(19) United States
(12) Patent Application Publication
(10) Pub. No.: US 2016/0089706 A1
(43) Pub. Date: Mar. 31, 2016

(54) CONTAINMENT PROCESS FOR OIL SANDS TAILINGS

(71) Applicant: SYNCRUDE CANADA LTD. in trust for the owners of the Syncrude Project, as such owners exist now and, Fort McMurray (CA)

(72) Inventors: PETER READ, Fort McMurray (CA); GAIL BUCHANAN, Fort McMurray (CA); NAN WANG, Edmonton (CA); GEOFFREY HALFERDAHL, Edmonton (CA); ROBERT DONAHUE, Edmonton (CA)

(21) Appl. No.: 14/869,618

(22) Filed: Sep. 29, 2015

Related U.S. Application Data
(60) Provisional application No. 62/057,410, filed on Sep. 30, 2014.

(51) Int. Cl. B09C 1/08; C02F 1/56; E02D 17/20; B09B 3/00; E02D 17/18; C02F 1/00; B09C 1/00

(52) U.S. Cl. CPC B09C 1/08; C02F 1/004; C02F 1/56; B09C 1/005; B09B 3/0016; B09B 3/0025; E02D 17/18; E02D 17/205; E02D 17/202; C02F 2103/10

(57) ABSTRACT

A process for containing tailings produced during an oil sands operation includes filling and containing the tailings in a geotextile container.

### FIELD OF THE INVENTION

The present invention relates to a process for containing oil sands tailings.

### BACKGROUND OF THE INVENTION

Oil sand generally comprises water-wet sand grains held together by a matrix of viscous heavy oil or bitumen. Bitumen is a complex and viscous mixture of large or heavy hydrocarbon molecules which contain a significant amount of sulfur, nitrogen and oxygen. The extraction of bitumen from sand using hot water processes yields large volumes of fine tailings composed of fine silts, clays, residual bitumen and water. Mineral fractions with a particle diameter less than 44 microns are referred to as “fines.” These fines are typically clay mineral suspensions, predominantly kaolinite and illite.

The fine tailings suspension is typically between 55 and 85% water and 15 to 45% fine particles by mass. Dewatering of fine tailings occurs very slowly.

Generally, the fine tailings are discharged into a storage pond for settling and dewatering. When first discharged in the pond, the very low density material is referred to as thin fine tailings. After a few years, when the fine tailings have reached a solids content of about 30-35 wt %, they are referred to as fluid fine tailings (FFT) and sometimes mature fine tailings (MFT), which still behave as a fluid-like colloidal material. The fact that fluid fine tailings behave as a fluid and have very slow consolidation rates significantly limits options to reclaim tailings ponds.

Recently, efforts have been undertaken to reduce the ponds, as by speeding dewatering of FFT. These efforts focus on removing the FFT from the ponds, as by dredging, and performing one or more of mechanical, chemical or electrical processes followed by placement of the partially dewatered tailings to form a landform. These methods can dewater the FFT tailings to some degree, for example to greater than 40 wt % solids. While this is dewatered beyond the state of the FFT tailings typically found in the pond, final dewatering is still required to increase the deposit strength to enable reclamation because even up to about 60% solids, the FFT still behaves as a liquid. Examples of partially dewatered fine tailings include those in centrifuge cake deposits and thin lift deposits.

Challenges facing the oils sands industry remain the reduction of reliance on the tailings ponds and removal of water from the fluid fine tailings so that the solids therein can be reclaimed in a shorter timeframe and no longer require residence time in these settling basins.

Accordingly, there is a need for further methods to contain tailings and to treat fine tailings to reduce their water content at a faster rate and to reclaim the solid material of the tailings and the land on which fine tailings are disposed in a shorter time-frame.

### SUMMARY OF THE INVENTION

The current application is directed to a process for containing oil sands tailings in a geotextile container. The present invention is particularly useful with, but not limited to, fluid fine tailings. The present invention enables tailings containment which sheds environmental water without surface crust formation, permits use of the contained tailings for landform formation and possibly provides enhanced dewatering of tailings.

In one aspect, a process for containing oil sands tailings is provided, comprising:
introducing a tailings feed to a geotextile container, the geotextile container fully surrounding the tailings feed.

In one embodiment, the geotextile container is permeable. In another embodiment, the geotextile container is impermeable and the tailings feed is essentially permanently retained therein.

In another aspect, a method for constructing a reclamation landform is provided, comprising:
placing a geotextile container on a selected ground surface;
filling the geotextile container with oil sand tailings;
sealing the geotextile container; and
configuring the geotextile container to construct a containment facility (e.g., a berm) or a reclamation landform.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIGS. 1A and 1B are schematic flow diagrams of embodiments of the present invention for dewatering oil sands tailings.

FIGS. 2A to 2D are schematic sectional views through a landform during stages of construction according to an embodiment of the present invention.

FIG. 3 is a schematic of an embodiment of the present invention for dewatering oil sands tailings.

FIG. 4 is a section through a geotextile container illustrating the process of dewatering.

FIG. 5 is a graphical representation of flocculated FFT dewatering results using geotextile containers.

FIG. 6 is a graphical representation of untreated FFT dewatering results using geotextile containers.

FIG. 7 is a graphical representation of treated FFT dewatering results using geotextile containers.

FIG. 8 is a graphical representation of the estimated results of a commercial scale test of FFT dewatering using geotextile containers based on tube surveyed heights.

FIG. 9 is a graphical representation of the actual measured solids content (wt %) of the various geotextile containers used in the commercial scale test of FFT dewatering with depth from the top of the containers.

FIG. 10 is a graphical representation of the peak vane shear strength (kPa) versus solids content (wt %) of the various geotextile containers used in the commercial scale test of FFT dewatering.

FIG. 11 is a graphical representation of the peak vane shear strength (kPa) versus chemical dosage (g/tonne) of additives of the various geotextile containers used in the commercial scale test of FFT dewatering.

FIG. 12 is a graphical representation of the particle size distribution of the FFT feed and the particle size of the FFT after one year of dewatering in the various geotextile containers used in the commercial scale test of FFT dewatering.

FIG. 13 is a schematic of a typical fluid Coking™ operation.

### DETAILED DESCRIPTION OF THE PREFERRED EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

The present invention relates generally to a process for containing tailings derived from oil sands operations to enable to create cells, dykes or embankments for containment of treated and untreated tailings, water or other fluid materials and for enhanced reclamation of tailings materials and disposal areas. The processes employ geotextile containers that are easy to transport when empty, and passive when deployed, but can be incorporated into or used to form containment or reclamation landforms.

The tailings can be from oil sands extraction operations or from later stages of oil sands operations such as bitumen froth treatment and bitumen upgrading. Tailings include residual solids waste streams that have been slurried with a solvent such as water.

A potential application at oil sands facilities for tailings containment using geotextiles includes coke slurry treatment. Geotextile containers can be filled with fluid coke, produced during bitumen upgrading in a fluid coker, that has been slurried out to tailings, the coke retained and used for building foundations (e.g., coke spur extensions) and the water treated by the fluid coke collected using impermeable underliners and used for reclamation purposes (i.e., End Pit Lake capping).

With respect to those tailings from extraction operations, the tailings can be from various stages of the extraction operations and can be used directly as produced or as stored, or can be treated before containment. Tailings can be contained and possibly dewatered using the geotextile containers. If dewatering is of interest, dewatering efficiency may be enhanced by chemically treating the tailings to increase the apparent particle size. Dewatering efficiency is directly proportional to polymer dosage.

In particular, a process for tailings containment has been invented that includes introducing the tailings to a geotextile container. The geotextile container may be enclosed such that the tailings are contained with no surface exposure. The containers have rigidity and resist degradation, such that they can be used to construct a reclamation landform.

In another aspect, a process for dewatering oil sands tailings has been invented that employs dewatering by introduction of the oil sand tailings to a geotextile container, wherein the tailings solids are retained, while the water passes out of the container. The water is removed from the solids via gravity drainage, seepage or evaporation.

Optionally, chemical treatment of tailings may be employed prior to dewatering to increase the apparent particle size.

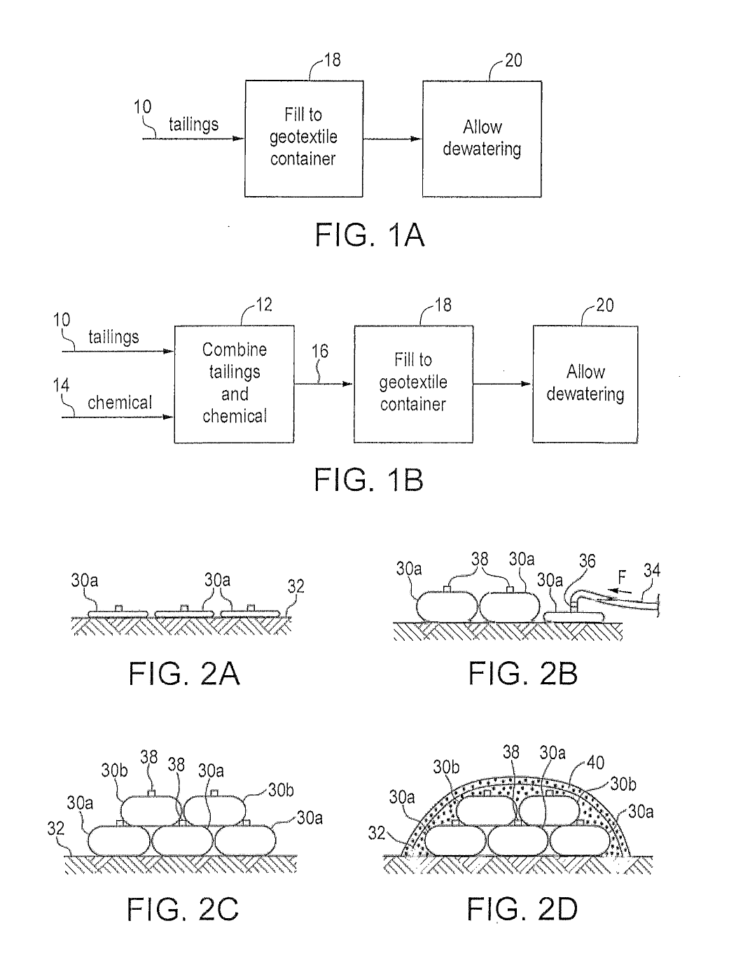

With reference to FIG. 1A, a schematic process diagram is shown according to one aspect of the invention. In the illustrated embodiment, tailings 10 are introduced 18 to a geotextile container. Thereafter, the geotextile container is left to dewater 20 the tailings. Dewatering is passive by water from the tailings migrating out of the geotextile container (through gravity drainage, seepage or evaporation) while the solids from the tailings are substantially retained within the geotextile container.

With reference to FIG. 1B, a schematic process diagram is shown according to another aspect of the invention. In the illustrated embodiment, tailings 10 are combined 12 with treatment chemical 14 to obtain a treated tailings feed 16. Treated tailings feed 16 is introduced 18 to a geotextile container. Thereafter, the geotextile container is left to dewater 20 the treated tailings feed by water passing out of the geotextile container (through gravity drainage, seepage or evaporation) while the solids are retained.

As used herein, the term “tailings” means by-products or wastes derived from oil sands operations including extraction, bitumen froth treatment and bitumen upgrading. The term “tailings” is meant to include fluid fine tailings (FFT) from tailings ponds, sand tailings, for example, from primary separation vessels or hydrocyclones, fine tailings from ongoing extraction/froth treatment operations (for example, thickener underflow or froth treatment tailings) which may bypass a tailings pond, slurried solids such as fluid coke slurried with water, or treated tailings from ponds or ongoing extraction operations. Tailings most useful in the invention may include those at least in part having a solids content of greater than about 10 wt %, including FFT with a solids content of about 10-45 wt % and partially consolidated fluid fine tailings with solids content of greater than 40 wt % such as greater than 45 wt %. If the tailings is from a tailings pond, such as FFT, the tailings is removed from the pond for introduction to the geotextile containers.

Treated tailings is a tailings stream that has been chemically treated to agglomerate or aggregate, for example, by any one or more of chemical treatments such as coagulation, such as by gypsum treatment, or flocculation, such as by treatment with a flocculant. The treatment causes the tailings solids to increase in apparent size as by some form of agglomeration/aggregation, to free more water from the tailings solids and to improve the filtering that may occur through the geotextile. If the original tailings is from a tailings pond, such as FFT, the tailings is removed from the pond for use to form treated tailings.

Geotextiles include synthetic fibres (geosynthetics) made into permeable, flexible fabric that has the ability to contain solids, while liquids can pass through. As such, in the current invention, geotextiles provide separation, reinforcement, filtration and drainage to dewater tailings. Geotextiles are typically made from polymer fibers (e.g., polypropylene) and can be woven or knit or matted into non-woven and needle punched materials. Geotextile containers useful herein are substantially enclosed such that tailings can be introduced to the container and contained therein. In one embodiment, the container is substantially enclosed and closeable, for example, with an interior chamber fully enclosed by geotextile and having an opening for access to the interior chamber that is sealable by a removable closure. For example, a useful container may be in the form of a bag or a tube with all sides, including bottom and top, formed of geotextile and including an opening, through which materials can be introduced to the interior of the container, and a removable closure for the opening. One geotextile bag is known as a TenCate Geotube™, available from Nicolon Corporation, doing business as TenCate Geosynthetics Americas, Pendergrass, Ga., USA and supplied in Canada by Layfield Environmental Systems Ltd., Layfield Geosynthetics and Industrial Fabrics, Edmonton, Alberta, Canada.

The geotextile container may be filled with tailings to achieve an internal pressure greater than the surrounding pressure (i.e. ambient). As such, dewatering may be facilitated by pressure alleviation. The geotextile container may have an overlying load to, again, facilitate dewatering by pressure alleviation. The surface load may be another tailings-filled geotextile container, or some other reclamation material (e.g., sand, clay, coke).

Dewatering may be achieved by leaving the filled container in place on a slightly sloped permeable or non-permeable surface and providing time for the water to drain from the container through the geotextile walls, while the solids are substantially retained within the geotextile walls. The geotextile wall also provides a barrier to prevent precipitation from penetrating back into dried retained tailings solids. The surface may be formed to facilitate gravity drainage and obstacles may be removed to avoid damage to the geotextile. For example, the surface may be graded, sloped (e.g., at 1% along the length to prevent the tube from rolling), lined with non-permeable or permeable synthetic liners formed to drain liquid (i.e. formed of sand and/or fitted with drainage pipes) and/or otherwise selected to drain water, such that water passing from the geotextile container can drain away substantially without pooling around the container. The surface may provide substantially dry surroundings about the container, such as exposure on substantially all sides except its bottom side (on which it rests and is supported) to air or to a substantially dry covering such as reclamation cover that is drier than the tailings to be dewatered.

To facilitate dewatering, the filled containers may be exposed to one or more freeze/thaw cycles. For example, the container may be selected with respect to size or shape such that when filled it is typically up to two meters high. As such, the filled container is generally no thicker than the usual freeze penetration, which is to a depth of about two meters.

Landforms can be constructed using the retained solids, even as they remain in the geotextile container. In one embodiment, a landform can be constructed by placing a geotextile container on a selected flat, levelled or slightly inclined ground surface, filling the geotextile container with oil sand tailings; and adapting the geotextile container to form a reclaimed landform.

In one embodiment, the method may include dewatering the tailings to remove tailings water from the geotextile container while the solids remain within the container. This may include, for example, exposing the geotextile container to air to permit water to pass from the oil sand tailings out of the geotextile container

FIGS. 2A to 2D show one possible tailings containment method, a possible landform and a possible method for constructing it. The method illustrated here includes dewatering of tailings from oil sand extraction.

In particular, a plurality of geotextile containers 30a, here each in the form of an enclosed and sealable geotextile tube or bag, are placed on a surface 32. The surface may be slightly sloped (typically about a 1% slope) and may have a capability for drainage downwardly, for example, through sand or drainage pipes, or overland, for example, via the slope. While surface 32 may be adjacent a pond, such as on a shore, a surface already covered in water, such as within a pond, does not allow suitable dewatering. In one embodiment, surface 32 is free of a water covering (i.e. pond water or other standing water), includes an amount of sand and may or may not have a gradual slope to enhance drainage.

In another embodiment, the geotextile tube may be stacked to form a dyke which can be constructed across a mine pit or formed into the berms for a cell to contain fluid tailings

As shown in FIG. 2B, each geotextile container 30a is filled, arrow F, with tailings and closed. Filling may introduce tailings to the containers, as by pumping through a line 34 attached to a fitting 36 on each container. The filled containers may be closed by securing a cap 38 or other form of closure on the fitting.

The geotextile container may be quite large and may be difficult to move once full. As such, in one embodiment, the containers may be placed where they are intended to define a portion of the intended landform to be constructed.

Depending on the desired shape of the landform, further geotextile containers 30b may be placed on top of the filled geotextile containers 30a and those further geotextile containers 30b may be filled. This forms a stack of filled geotextile containers. In the illustrated embodiment, the landform is intended to be a hummock and therefore, the containers are stacked toward a single high point or crest. Other shapes are possible. For instance, a dyke may be constructed of stacked, filled geotextile containers to contain tailings or other materials.

The tailings within the geotextile containers 30a, 30b dewater passively in place, which includes exposing the geotextile container to air to permit water to pass from the oil sand tailings out of the geotextile container. This occurs by draining including by evaporation. Since some dewatering occurs by evaporation, the containers 30a covered by other containers or with another cover, and thus with less exposed surface, may dewater at a slower rate than the upper containers 30b that have more exposed surface area. However, stacking of filled geotextile containers will exert a pressure force (load) on the underlying containers likely enhancing dewatering over containers with no upper load.

The tailings are contained within the container. The upper surface of geotextile protects the tailings from rewetting due to environmental water, such as rain and snow. Using the geotextile containers, liquid including environmental water, such as precipitation, tends to shed rather than penetrating the container to rewet the dried, retained tailings solids.

The containers 30a, 30b may be exposed to freeze-thaw effects to facilitate dewatering.

As dewatering proceeds and space develops within the containers 30a, 30b, they may be refilled as with further tailings. Refilling may be carried out one or more times. However, care may be taken as filtration performance may deteriorate over time when the containers are reused.

Containers 30a, 30b may readily reach shear strengths suitable to provide a trafficable surface towards reclamation. For example, in one embodiment, after dewatering of tailings in geotextile containers for a period of about a month, measured vane shear strengths ranged from 11 to 25 kPa for solids contents of between 65 and 70 wt %.

After a suitable dewatering period, the containers may be adapted to finish construction of the landform. For example, the containers may be used as is or they may be broken open.

Since the geotextile material is generally acceptable to remain in the environment, the geotextile may be removed, if desired. A reclamation cover 40 may be applied, which may include sand, soil, coke, vegetation, etc. as shown in FIG. 2D. The reclamation cover 40 may introduce a load to enhance dewatering of material contained in the geotextile containers. If the tailings have been dewatered, the geotextile containers 30a, 30b may be an integral part of the resulting landform or the geotextile material may be excavated and removed. The reclamation cover or dewatered solids can be graded or otherwise formed.

While dewatering has been disclosed above, it is to be understood that a geotextile container could be selected for containment of tailings even without dewatering. The empty containers facilitate handling and the filled containers become rigid, such that regardless of whether the tailings dewater or not, they may have use in landform creation and stabilization. Filled geotextile containers may also be used as break waters to reduce erosional impact in channels and flow ways.

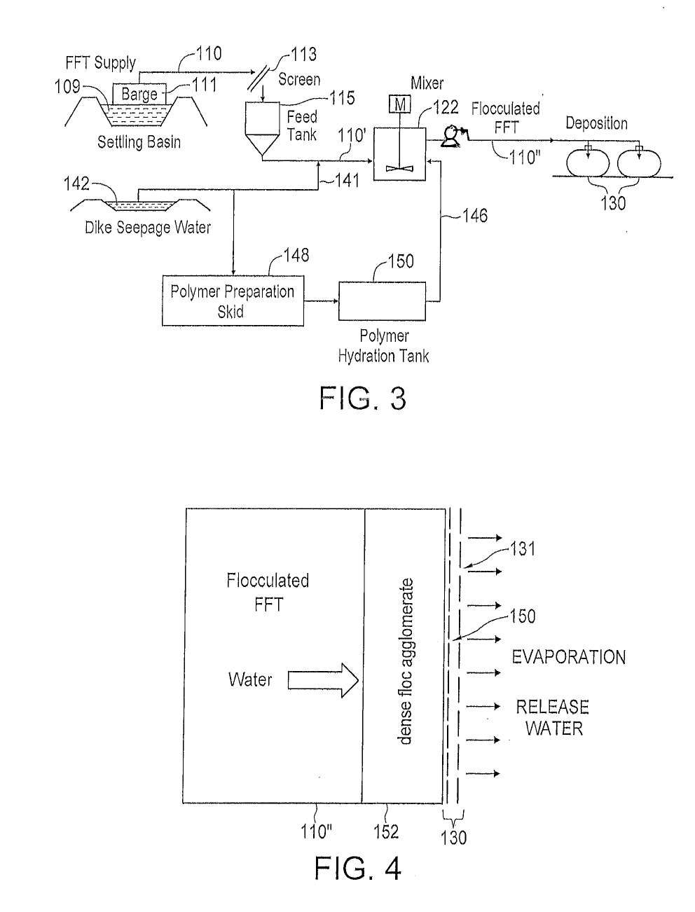

Another embodiment of a method for dewatering is shown in FIG. 3 using FFT 110 obtained from a tailings pond settling basin 109, as the source of tailings. However, it should be understood that the fine tailings treated according to the process of the present invention are not necessarily obtained from a tailings pond and may also be obtained from ongoing oil sands extraction operations.

The tailings stream from bitumen extraction is typically transferred to a tailing storage facility such as a tailings settling basin where the tailings stream separates into an upper water layer, a middle FFT layer, and a bottom layer of settled solids. The FFT 110 is removed from the pond 109 from between the water layer and solids layer via a dredge or floating barge 111 having a submersible pump. In one embodiment, the FFT 110 has a solids content ranging from about 10 wt % to about 45 wt %. In another embodiment, the FFT 110 has a solids content ranging from about 30 wt % to about 45 wt %. In one embodiment, the FFT 110 has a solids content ranging from about 37 wt % to about 40 wt %. The FFT is passed through a screen 113 to remove any oversized materials. The screened FFT 110′ is collected in a vessel such as a tank 115.

In one embodiment (not shown), the screened FFT 110′ is then pumped from the tank 115 to fill geotextile containers for dewatering. However, treatment of the FFT to increase its apparent particle size may enhance dewatering and facilitate use of geotextiles. Thus, in the illustrated embodiment, screened FFT 110′ is pumped from tank 115 for treatment in a mixing tank 122 such as one comprising a tank body and blades.

If desired, screened FFT 110′ may be diluted, as by introduction of dilution water 141. Dilution water 141 may be from various sources, such as for example, any low solids content process affected water such as dyke seepage water 142.

A treatment chemical is then combined with the screened FFT. While various treatment chemicals are useful, in this illustrated method the treatment chemical is a flocculant 146, but may alternately be a coagulant or a combination of flocculant and coagulant. The flocculant may be added directly to mixing tank 122 or introduced “in-line” into the flow of the screened FFT 110′, for example, prior to entering the mixer 122. As used herein, the term “in-line” means to inject into a flow contained within a continuous fluid transportation line such as a pipe or another fluid transport structure which preferably has an enclosed tubular construction.

As used herein, the term “flocculant” refers to a reagent which bridges the neutralized or coagulated particles into larger agglomerates, resulting in more efficient settling. Flocculants useful in the present invention are generally anionic, nonionic, cationic or amphoteric polymers, which may be naturally occurring or synthetic, having relatively high molecular weights. Preferably, the polymeric flocculants are characterized by molecular weights ranging between about 1,000 kDa to about 50,000 kDa. Suitable natural polymeric flocculants may be polysaccharides such as dextran, starch or guar gum. Suitable synthetic polymeric flocculants include, but are not limited to, charged or uncharged polyacrylamides, for example, a high molecular weight polyacrylamide-sodium polyacrylate co-polymer.

Other useful polymeric flocculants can be made by the polymerization of (meth)acrylamide, N-vinyl pyrrolidone, N-vinyl formamide, N,N dimethylacrylamide, N-vinyl acetamide, N-vinylpyridine, N-vinylimidazole, isopropyl acrylamide and polyethylene glycol methacrylate, and one or more anionic monomer(s) such as acrylic acid, methacrylic acid, 2-acrylamido-2-methylpropane sulphonic acid (ATBS) and salts thereof, or one or more cationic monomer(s) such as dimethylaminoethyl acrylate (ADAME), dimethylaminoethyl methacrylate (MADAME), dimethydiallylammonium chloride (DADMAC), acrylamido propyltrimethyl ammonium chloride (APTAC) and/or methacrylamido propyltrimethyl ammonium chloride (MAPTAC).

In one embodiment, the flocculant 146 comprises an aqueous solution of an anionic flocculant. Anionic flocculants are obtained either by hydrolysis of the amide groups on the polyacrylamide chain or by copolymerization of the polyacrylamide with a carboxylic or sulphonic acid salt. The most commonly used is acrylic acid. The acrylate copolymer can contain a single or multivalent cation. The anionicity of these copolymers can vary between 0% and 100% depending the ratio of monomers involved. The molecular weight may be 3 to 30 million Daltons.

In one embodiment, flocculant 146 comprising an aqueous solution of an anionic polyacrylamide is employed preferably having a relatively high molecular weight (about 10,000 kD or higher) and medium charge density (about 20-35% anionicity). In one embodiment, for example, the flocculant may be a high molecular weight polyacrylamide-sodium polyacrylate co-polymer or a high molecular weight anionic polyacrylamide-multivalent (i.e. calcium, magnesium, iron or aluminum) polyacrylate co-polymer.

The flocculant or other additive would be selected according to the FFT composition and process conditions, as would the dosage of said flocculant or other additive.

The flocculant 146 is supplied from a flocculant make-up system for preparing, hydrating and dosing of the flocculant 146. The flocculant is made up with water, such as any low solids content oil sands process-affected water (OSPW) for example water 142. Flocculant make-up systems are well known in the art, and typically include a polymer preparation skid 148 and one or more hydration or polymer solution storage tanks 150. In one embodiment, the dosage of flocculant 146 in the FFT ranges from about 100 grams to about 3000 grams per tonne of solids in the FFT. The flocculant concentration is selected to optimize the mixing effectiveness with the tailings stream to be used in the geotextile containers. Effective polymer concentrations would be between 0.1% to 0.5 wt % polymer in solution.

The water 141 is provided to control the density or solids content of the tailings stream to be treated. This constant feed density helps to maintain consistency in the mixing of the flocculant solution and the tailings suspension. When the flocculent 146 contacts the FFT 110′, it starts to react to form flocs of multiple chain structures and FFT minerals. The FFT 110′ and flocculant 146 are combined, here illustrated as within the mixer 122. Since flocculated material may be shear-sensitive, it should be mixed accordingly. Suitable mixers 122 include, but are not limited to, T mixers, static mixers, dynamic mixers, and continuous-flow stirred-tank reactors (CSTR). Optimum mixing does not require feed density control, but it is desirable.

Flocculation produces a suitable feed of flocculated FFT 110″ which can be delivered for deposition into one or more sealable geotextile containers 130.

In an alternate embodiment, the treatment chemical may be a coagulant alone or in combination with the flocculant. If a coagulant is employed, the process flow diagram is similar to that of FIG. 3, wherein the coagulant is combined with the FFT after the FFT is removed from the pond and before introduction to the geotextile containers. For example, using a system as illustrated in FIG. 3, the coagulant may be added in-line to a flow of FFT prior to entering, or directly into, the mixing tank 122. If coagulant is used with a flocculant, the coagulant is often added to the FFT before the addition of flocculant. Sometimes, however, the coagulant is added to the FFT after the addition of flocculant.

As used herein, the term “coagulant” refers to a reagent which neutralizes repulsive electrical charges surrounding particles to destabilize suspended solids and to cause the solids to agglomerate. Suitable coagulants include, but are not limited to, gypsum, lime, alum, polyacrylamide, or any combination thereof. In one embodiment, the coagulant comprises gypsum or lime. Sufficient coagulant is added to the FFT to initiate neutralization. In one embodiment, the dosage of the coagulant gypsum ranges from about 100 grams to about 3000 grams per tonne of solids in the FFT.

Dilution water is provided to control the density or solids content of the tailings stream to be treated. This constant feed density helps to maintain consistency in the mixing of the coagulant and the tailings. The FFT and coagulant are blended together within the agitated feed tank or in the pipeline when no feed tank is used. Agitation is conducted for a sufficient duration in order to allow the coagulant to dissolve in the available water and agglomerate the FFT. In one embodiment, the duration is at least about seven minutes.

The coagulated FFT is then introduced to a geotextile container for dewatering. If flocculant is also to be employed, the coagulated FFT is mixed with flocculant, for example, in a manner similar to that described above in respect of addition of flocculant 146 in FIG. 3.

At the selected site, the geotextile containers 130 are arranged and possibly stacked to await dewatering by drainage through release of water and evaporation from the containers as well as by consolidation and freeze-thaw.

Regardless of the form of tailings, FFT or not, with or without chemical treatment, geotextile containers 130 for commercial-scale application (e.g., capacity greater than 150 m³) are selected and specified based on preliminary lab-scale test results. To facilitate freeze-thaw effects, the containers may be selected to provide a filled thickness of typically 2 m or less. In one embodiment, a geotextile container known as a Tencate Geotube® is employed having a filled volume of at least about 200 m³ and generally about 200 to 250 m³ and a filled bottom surface dimension of about 120 to 150 m² with a filled thickness, recommended by the manufacturer, of 2 m or less. The filled diameter (or height) will depend on the Geotube® factor of safety with the density of the fill material.

Geotextile containers 130 are formed of high tensile strength, geosynthetic fabric materials. Woven or non-woven geotextiles can be designed and manufactured into containers to provide the best combination of filtering and strength for dewatering applications. An optimum geotextile strength and pore size is selected depending upon intended fill pressures and volumes, the nature of the tailings, the choice and effectiveness of the tailings treatment and field application.

The geotextile container should have sufficient strength to accommodate the internal pressures greater than ambient and to maintain its shape to some degree, such that it can be filled to a selected fill height. In one embodiment, the geotextile container includes walls having a minimum average tensile strength of at least 350 lbs/in, including with respect to the geotextile wall material and the seam strength. In one embodiment, for example, a geotextile may be employed that has a minimum average wide width tensile strength (ASTM D4595) of at least 350 lbs/in and possibly at least about 400 lbs/in.

At the same time, pore size should be selected with consideration to the tailings to be contained. If full containment is desired, the geotextile forming the container may have no pores or a very small pore size. If dewatering is desired, pore size may be selected to ensure that while there may be some solids leakage, after a suitable period such as one week, drainage is predominantly of substantially solids-free water. In one embodiment, for dewatering a geotextile with an Apparent Opening Size (AOS) of less than 500 microns may be useful. However, smaller pore sizes such as of less than 350 microns, may be needed for tailings with predominately smaller particle size. The commercial Geotube® test (discussed below) showed that the commercial dewatering tube GT500 (pore size AOS of 425 microns) was sufficient for dewatering polymer-treated FFT. In some embodiments, no inner liner was required, which would be more cost effective.

Some woven geotextiles are made of polypropylene, for example high-tenacity, monofilament polypropylene yarns. Some useful woven geotextiles are, for example, TenCate GT500 with an Apparent Opening Size (AOS) of 425 microns, TenCate Mirafi® FW500 with an AOS of 300 microns, and TenCate Mirafi® FW700 with an AOS of 212 microns, all available from TenCate Geosynthetics Americas.

Some non-woven geotextiles also provide good solids and water separation and drainage performance. Non-woven geotextiles may have increased flexibility over woven geotextiles. Some non-woven materials have similar AOS to woven geotextiles but have lower tensile strength and weight, reducing total weight and manufacturing cost of the dewatering containers when used as liners. Non-woven geotextiles are mainly used for filtration, separation, protection and drainage. Some useful woven geotextiles are, for example, Mirafi™ N160 or Layfield LP6 each with an AOS of 212 microns and Mirafi™ N1100 or Layfield LP10 each with an AOS of 150 microns, all of which are non-woven, needle-punched geotextiles of polypropylene fibers formed into a stable network. The Mirafi™ products are available from TenCate Geosynthetics Americas and the Layfield products are available from Layfield Environmental Systems Ltd.

With reference to FIG. 4, in some cases, the geotextile container 130 may have a woven outer wall 131 and may, if desired, be manufactured with a liner 150 of woven or non-woven geosynthetic to further reduce apparent opening size, while relying on the strength of the outer woven wall 131 of the container. Such a wall construction may enable increased fill height (i.e., up to 2 m) and capacity with a smaller AOS.

The treated FFT 110″ to be dewatered via the geotextile container 130 have some agglomerated particles with a size that cannot readily pass through the pore size (AOS) of the geotextile of the bag, allowing them to be retained in the container while the water can leave through the pores of the geotextile.

Thus, the geotextile initially acts alone as a filter allowing the water and possibly some inefficiently captured smaller particles and hydrocarbon (i.e., bitumen) to drain through, while retaining the agglomerated solids. Eventually, a floc agglomerate 152 tends to form against the geotextile wall.

While FIG. 4 illustrates the process using treated FFT, with appropriate selection of geotextile pore size, untreated tailings may also be dewatered in a geotextile container. In such a system, while initially there may be some seepage of solids and hydrocarbon through the geotextile pores with the water, a filter cake tends to form against the geotextile wall. Geotextile containers may require an AOS of less than 425 microns to contain FFT.

However, dewatering of tailings that are chemically treated to have the agglomerate formation is enhanced over untreated fluid fine tailings when using geotextile container dewatering. Dewatering efficiency may be assessed based hydrocarbon, water and solids analyses of the dewatering contents and on the release water. Such analysis may include: (i) solids density of the container contents, (ii) solids retention within the container, which relates to solids content in the release water and (iii) release water volume. The release water and container contents may also be analyzed to assess the degree of hydrocarbon retention. Other performance factor studies such as viscosity and yield point may also be of interest as well as geotechnical properties including shear strengths.

To be useful in dewatering, the process should dewater tailings such as FFT to achieve a high clay fines/solids concentration of, for example, greater than about 70% in about two years or longer or to provide a deposit with sufficient strength to be “reclamation ready”.

Bitumen and other hydrocarbons should be mostly retained within the geotextile bags, particularly after a “filter cake” or floc agglomerate forms against the geotextile wall. In one embodiment, greater than 98% of the residual bitumen in the tailings was retained within the bags.

Release water may initially have high solids content, in fact similar to the tailings solid content, the water within a week and generally within 4 days has a solids content of less than 5 wt % solids and often less than 1 wt % solids.

Exemplary embodiments of the present invention are described in the following examples, which are set forth to aid in the understanding of the invention, and should not be construed to limit in any way the scope of the invention as defined in the claims which follow thereafter.

### Example 1

Three lab-scale experiments were initially conducted to determine the suitability of geotextile containers for dewatering flocculated FFT. Geotextile bags were each placed on a steel grate, filled with flocculated FFT (approximately 40 L) and allowed to drain until water drainage stopped.

In Tests 1 and 2, after an initial period of dewatering indoors, the geotextile bags were placed outside to freeze quickly in winter conditions and then brought inside to thaw on the drainage stand. The amount of water lost from the geotextile bag was calculated by weighing the drainage water and the bag. Once the bag had thawed and finished draining, it remained on the drainage stand to continue dewatering by evaporation through the bag.

For Test 3, a 46 kg sand load was applied to the geotextile bag to investigate the behavior of confined flocculated FFT if physically loaded as would happen if geotextile bags were stacked or capped with a sand layer.

The geotextile bags used were 20 L bench-scale test bags (52 cm by 52 cm empty). Each bag had a central opening on one side. The central opening was threaded and closed by a cap. The bags were each formed of Mirafi® FW500 geotextile. Mirafi® FW500 geotextile is composed of high-tenacity monofilament and slit tape polypropylene yarns, woven into a stable network such that the yarns retain their relative position. Mirafi® FW500 geotextile is inert to biological degradation and resists naturally encountered chemicals, alkalis, and acids.

Table 1 presents the mechanical and physical properties of the Mirafi® FW500 geotextile.

TABLE 1
Mechanical and physical properties of Mirafi ® FW500 geotextile

| | | | Minimum Average | |
|---|---|---|---|---|
| | | | Roll Value | |
| Mechanical Properties | Test Method | Unit | MD | CD |
| Wide Width Tensile Strength | ASTM D4595 | lbs/in (kN/m) | 183 (32.1) | 250 (43.8) |
| Grab Tensile Strength | ASTM D4632 | lbs (N) | 325 (1446) | 425 (1892) |
| Grab Tensile Elongation | ASTM D4632 | % | 15 | 15 |
| Trapezoid Tear Strength | ASTM D4533 | lbs (N) | 135 (601) | 150 (668) |

| | | | |
|---|---|---|---|
| CBR Puncture Strength | ASTM D6241 | lbs (N) | 1000 (4450) |
| Apparent Opening Size (AOS)¹ | ASTM D4751 | U.S. Sieve (mm) | 50 (0.30) |
| Percent Open Area | COE-02215 | % | 4 |
| Permittivity | ASTM D4491 | sec⁻¹ | 0.51 |
| Permeability | ASTM D4491 | cm/sec | 0.027 |
| Flow Rate | ASTM D4491 | (gal/min/ft²) l/min/m² | 35 (1426) |
| UV Resistance (at 500 hours) | ASTM D4355 | % strength retained | 70 |

Test 1 was conducted on 36.1 kg of 20 wt. % solids FFT (7.22 kg of solids). These tests used polymer A, which is an anionic polyacrylamide-sodium polyacrylate co-polymer with a high molecular weight (about 10,000 kD or higher) and a medium charge density (about 20 to 35% anionicity). The polymer is available as SNF 3338 provided by SNF Group. The FFT was flocculated in batches by adding a 4 wt. % solution of the flocculant at 210 ml/min for 4 min 20 sec (910 ml polymer total). Test 2 was conducted on 38.1 kg of 35.2 wt. % solids FFT (12.3 kg of solids). The FFT was flocculated in two batches by adding a 4 wt. % solution of polymer A at 510 ml/min for 3.5 min (1838 ml of polymer total). Test 3 was similar to Test 2 but used 37.4 kg of 35.2 wt. % solids FFT (13.0 kg of solids) and was flocculated using 1812 ml of the 4 wt. % solution of polymer A.

In all tests the FFT and polymers were mixed at 600 rpm in a baffled mixing apparatus developed specifically to flocculate FFT. Each batch was mixed, flocculated and poured into the bag as quickly as possible. The flocculated material was transferred to 20 L pails, weighed and poured into the geotextile bag to establish the water balance.

In Test 3, the geotextile bag was immediately loaded with a 45.7 kg bag of sand on the drainage stand, creating an estimated pressure of about 1.5 kPa on the bag contents.

The weights of drained water and of the bag were measured each day. At the completion of the test the bag was cut open, hand held vane shear tests were performed and samples were collected for density analysis.

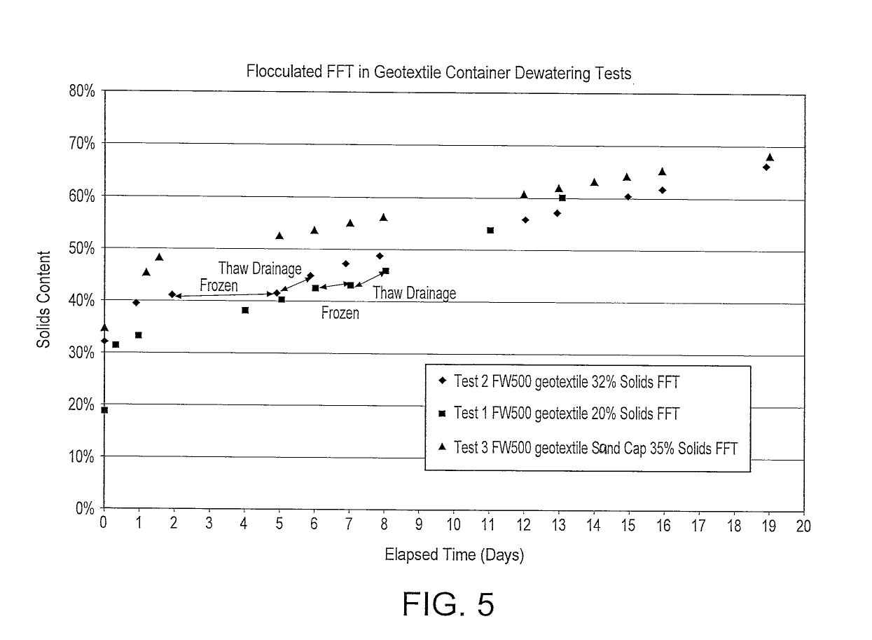

The changing average solids content of each bag, based on weight loss measurements, are presented in FIG. 5.

In Test 1, which started with FFT having 20 wt. % solids, 12.3 L of water seeped from the geotextile bag during the first 24 hours with an increase in solids content of 10 wt. % due solely to flocculation and drainage of release water. Drainage was complete in 4 days, after which the primary mode of water loss was by evaporation. The HVAC system in the lab targets a relative humidity of 20% for lab air during winter months, which provided a constant evaporative flux from the surface of the geotextile bags. An open pan (25 cm by 34 cm) of water was used to quantify evaporation rates. With the bag sitting on the grate and drainage stand, evaporation occurred from both the top and bottom surfaces. The evaporation rate from the geotextile bag in Test 1 decreased with time and ranged from 0.6 to 0.9 kg/day (1.6 to 1.1 kg/day/m² of bag surface area). After 6 days, following cessation of dripping, the bag was placed outside and frozen solid at −25° C. for 24 hours and then returned to the drainage stand inside to thaw. Upon thawing 0.264 kg of water seeped out of the bag. The bag remained on the drainage stand for another six days to dewater by evaporation. The average solids contents measured on 2 samples at the end of the test was 70 wt. %, higher than the calculated 60 wt. % solids content based on the weight loss of the entire bag.

In Test 2 (34 wt. % solids FFT), 7.2 L of water seeped from the bag during the first 48 hours, after which it was put outside and frozen solid at −25° C. for 3 days. The frozen bag was brought inside to thaw on the drainage stand, releasing an additional 1.59 kg of water over 2 days. The bag remained on the drainage stand for another 12 days to dewater by evaporation. Pan evaporation in the lab during this time was 181 to 176 g/day (1.6 to 2.1 kg/day/m² of pan surface area) while bag evaporation decreased from 0.9 kg/day to 0.45 kg/day (1.72 to 0.83 kg/day/m² of bag surface area). At the end of the test, the final solids content ranged from 69 to 77 wt. % with an average of 73 wt. % from three samples. As with Test 1, the average measured solids content from samples (73 wt. %) was higher than those calculated on weight loss (66 wt. %) of the bag during the experiment.

Test 3 investigated the potential use of a sand cap or stacking to enhance dewatering by adding a physical load. It used FFT at 35 wt. % solids content, flocculated as noted above and had a sand load that provided an estimated pressure of 1.5 kPa on the top surface of the bag. No solids leaked from the bag when the sand load was applied, and within 30 hours 8.3 L of water escaped increasing the solids content to 45 wt. %. The pan evaporation rate ranged from 2.65 to 1.86 kg/day/m² while the geotextile bag evaporation rates decreased from 0.46 to 0.27 kg/day, about half of the rate measured in Tests 1 and 2. This reduction in bag evaporation rate can be explained by considering that the plastic bag sand load covered the top surface of the geotextile bag, thereby reducing the evaporation surface by half. The evaporation rate per exposed area of bag surface was calculated to be 1.7 to 1.0 kg/day m² during the test, similar to Tests 1 and 2. After 18 days of evaporation on the stand the FFT had increased to a bag average of 68 wt. % based on weight loss.

The discrepancy between the measured and solids contents calculated based on weight loss during the test was investigated by detailed sampling of the solids inside the bag at the end of Test 3. Ten samples with solids contents between 48 and 72 wt. % were collected from different locations within the bag and analyzed for solids contents as shown in Table 2. Wetter FFT in the center of the bag volume with dryer FFT towards the thinner outer volume illustrates a variable FFT dewatering profile within the bag with drier FFT nearer the bag outer edges. The average solids content for 10 samples was 65 wt. %, consistent with the calculated 68 wt. % based on weight loss of the entire bag.

Vane shear measurements were conducted at the end of Test 3 on some of the 10 samples collected. The measurements were made using a hand held vane shear instrument with 25 mm diameter by 50 mm long vanes. Vane shear measurements ranged from 11 to 25 kPa for solids contents between 65 and 70 wt. % as shown in Table 2.

TABLE 2
Solids content and vane shear measurements on FFT in Test 3

| | | Vane shear | |
|---|---|---|---|
| Sample | Solids Content | (Kpa) | location |
| GB-3-1 | 61% | | around cap thickest part of |
| | | | FFT in geotube |
| GB-3-2 | 65% | | 10 cm out from cap |
| GB-3-3 | 69% | | 15 cm out from cap |
| GB-3-4 | 48% | | Below cap center of geotube |
| GB-3-5 | 72% | | 25 cm out from cap thinner |
| | | | material at edge |
| GB-3-6 | 65% | 11 | 10 cm out from cap thickest |
| | | | part FFT in geotube |
| GB-3-7 | 65% | 11 | 10 cm out from cap thickest |
| | | | part FFT in geotube |
| GB-3-8 | 68% | 20 | 15 cm out from cap |
| GB-3-9 | 69% | 19 | 15 cm out from cap |
| GB-3-10 | 70% | 25 | 25 cm out from cap |

A significant difference between the 20 and 34 wt. % solids content FFT is that the higher density FFT contains roughly twice as much fine solid than the lower density FFT, making it more efficient per mass of solids.

The tests showed beneficial results overall.

### Example 2

Samples of untreated FFT were obtained from West In-Pit Lake at Syncrude operations. Flocculated FFT (produced with polyacrylamide polymer A dosed at 1350-1500 g/tonne solids FFT) were collected from Syncrude operations. These tailings were used for three series of tests. The tests were conducted as summarized in Table 3.

TABLE 3
Summary of tests using untreated FFT and treated FFT

| | | | | AOS | AOS | Initial Solids |
|---|---|---|---|---|---|---|
| Bag Test | Bag Fill | Bag Name | Geotextile | Microns | US Sieve | (wt %) |
| 1 | FFT | GT500 | Woven | 425 | 40 | 34.1 |
| | | FW700 | Woven | 212 | 70 | |
| 2 | FFT | FW500 | Woven | 300 | 50 | 34.1 |
| | | FW700 | Woven | 212 | 70 | |
| | | N160 (LP6) | Non-woven | 212 | 70 | |
| | | N1100 (LP10) | Non-woven | 150 | 100 | |
| 3 | Floc'd FFT | GT500 | Woven | 425 | 40 | 27.0 |
| | | FW500 | Woven | 300 | 50 | |
| | | FW700 | Woven | 212 | 70 | |
| | | N160 (LP6) | Non-woven | 212 | 70 | |

The geotextile bags used were 20 L bench-scale test bags (52 cm by 52 cm empty) formed of Mirafi® geotextile. Tables 4 to 7 provide a summary of the geotextiles employed. See also Table 1 for information on FW500.

TABLE 4
Mechanical Properties of TenCate Geotube ® GT500 Woven Dewatering Geotextile

| | | | Minimum Average | |
|---|---|---|---|---|
| | | | Roll Value | |
| Mechanical Properties | Test Method | Unit | MD | CD |
| Wide Width Tensile Strength | ASTM D4595 | lbs/in (kN/m) | 450 (78.8) | 625 (109.4) |
| (at ultimate) | | | | |
| Wide Width Tensile Elongation | ASTM D4595 | % | 20 (max.) | 20 (max.) |

| | | | |
|---|---|---|---|
| Factory Seam Strength | ASTM D4884 | lbs/in (kN/m) | 400 (70) |
| CBR Puncture Strength | ASTM D6241 | lbs (N) | 2000 (8900) |
| Apparent Opening Size (AOS) | ASTM D4751 | U.S. Sieve (mm) | 40 (0.43) |
| Water Flow Rate | ASTM D4491 | gpm/ft² | 20 (813) |
| | | (l/min/m²) | |
| UV Resistance | ASTM D4355 | % | 80 |
| (% strength retained after 500 hrs) | | | |

TABLE 5
Mechanical Properties of TenCate Mirafi ® FW700 woven polypropylene geotextile

| | | | Minimum Average | |
|---|---|---|---|---|
| | | | Roll Value | |
| Mechanical Properties | Test Method | Unit | MD | CD |
| Wide Width Tensile Strength | ASTM D4595 | lbs/in (kN/m) | 225 (39.4) | 145 (25.4) |
| Grab Tensile Strength | ASTM D4632 | lbs (N) | 370 (1647) | 250 (1113) |
| Grab Tensile Elongation | ASTM D4632 | % | 15 | 15 |
| Trapezoid Tear Strength | ASTM D4533 | lbs (N) | 100 (445) | 60 (267) |

| | | | |
|---|---|---|---|
| CBR Puncture Strength | ASTM D6241 | lbs (N) | 950 (4228) |
| Apparent Opening Size (AOS)¹ | ASTM D4751 | U.S. Sieve (mm) | 70 (0.212) |
| Percent Open Area | COE-02215 | % | 4 |
| Permittivity | ASTM D4491 | sec⁻¹ | 0.28 |
| Permeability | ASTM D4491 | cm/sec | 0.01 |
| Flow Rate | ASTM D4491 | gal/min/ft² (l/min/m²) | 18 (733) |
| UV Resistance (at 500 hours) | ASTM D4355 | % strength retained | 90 |

TABLE 6
Mechanical Properties of TenCate Mirafi ® 160N needle-punched nonwoven
polypropylene geotextile (Mirafi ® 160N = LP6)

| | | | Minimum Average | |
|---|---|---|---|---|
| | | | Roll Value | |
| Mechanical Properties | Test Method | Unit | MD | CD |
| Grab Tensile Strength | ASTM D4632 | lbs (N) | 160 (712) | 160 (712) |
| Grab Tensile Elongation | ASTM D4632 | % | 50 | 50 |
| Trapezoid Tear Strength | ASTM D4533 | lbs (N) | 60 (267) | 60 (267) |

| | | | |
|---|---|---|---|
| CBR Puncture Strength | ASTM D6241 | lbs (N) | 410 (1825) |
| Apparent Opening Size (AOS)¹ | ASTM D4751 | U.S. Sieve (mm) | 70 (0.212) |
| Permittivity | ASTM D4491 | sec⁻¹ | 1.5 |
| Flow Rate | ASTM D4491 | gal/min/ft² | 110 (4481) |
| | | (l/min/m²) | |
| UV Resistance (at 500 hours) | ASTM D4355 | % strength | 70 |
| | | retained | |

TABLE 7
Mechanical Properties of TenCate Mirafi ® 1100N needle-punched
nonwoven polypropylene geotextile (N1100 = LP10)

| | | | Minimum Average | |
|---|---|---|---|---|
| | | | Roll Value | |
| Mechanical Properties | Test Method | Unit | MD | CD |
| Grab Tensile Strength | ASTM D4632 | lbs (N) | 250 (1113) | 250 (1113) |
| Grab Tensile Elongation | ASTM D4632 | % | 50 | 50 |
| Trapezoid Tear Strength | ASTM D4533 | lbs (N) | 100 (445) | 100 (445) |

| | | | |
|---|---|---|---|
| CBR Puncture Strength | ASTM D6241 | lbs (N) | 700 (3115) |
| Apparent Opening Size (AOS)¹ | ASTM D4751 | U.S. Sieve (mm) | 100 (0.15) |
| Permittivity | ASTM D4491 | sec⁻¹ | 0.8 |
| Flow Rate | ASTM D4491 | gal/min/ft² (l/min/m²) | 75 (3056) |
| UV Resistance (at 500 hours) | ASTM D4355 | % strength retained | 70 |

Bag Test 1: Two geotextile weaves were selected for preliminary testing to dewater untreated FFT: GT500 (AOS 425 microns) and FW700 (AOS 212 micron).

The GT500 large weave bag was unsuccessful in retaining the untreated FFT, which passed right through the geotextile with minimal capture of FFT fines. Better results were achieved with solids retention in the FW700 test bag. In particular, the FW700 test bag did retain the FFT to some degree but a moderate amount extruded slowly through the geotextile and sloughed off. The filled FW700 bag was left to dry at ambient temperatures and conditions and sampled weekly through the centre fill port for 28 days. With FW700 solids density increased from initially 34.1 wt % in the untreated FFT to 80.7 wt % solids in 28 days. The results are shown in Table 8.

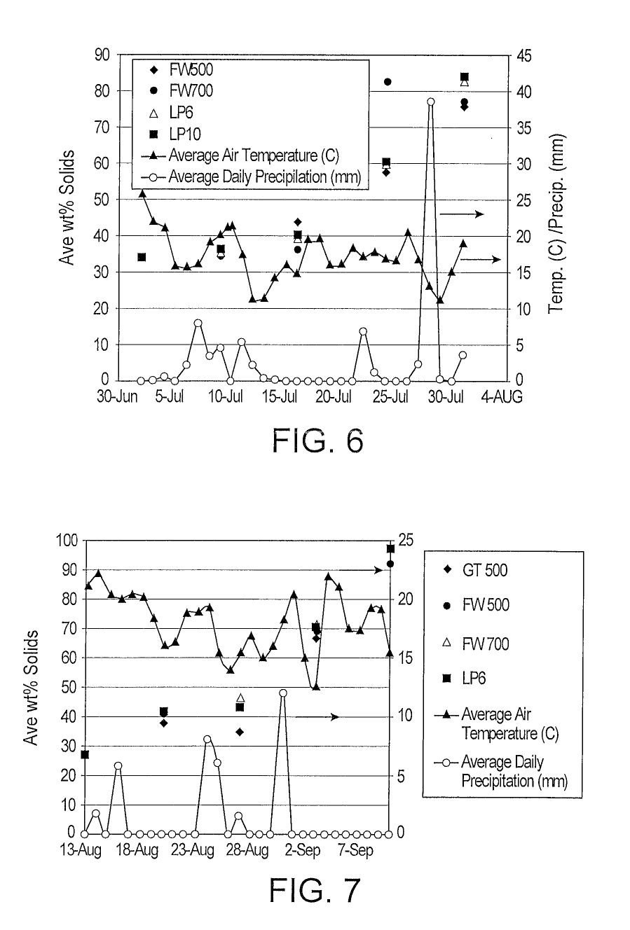

Bag Test 2: More tests of dewatering untreated FFT were conducted using further various woven and non-woven TenCate Mirafi® test bags (see Table 3). Weighed test bags were filled with measured volumes of untreated FFT, followed by weekly sampling and analysis of solid samples from the centre port of the bags. Measured solids content increasing from 34.1 wt % to a range of 75.4 to 83.9 wt % in 28 days. The results for each bag are shown in Table 8. A graph of the weekly sampling data is found in FIG. 6.

Bag Test 3: A 3^{rd} set of bag tests were conducted using a variety of woven and non-woven TenCate Mirafi® test bags (see Table 3) and FFT flocculated with anionic polyacrylamide polymer A. All of the geofabrics tested, including GT500 test bags, were successful in retaining FFT solids with <1 wt % solids expressed with the water (collected in pans below the bag). After 26 days: solids content increased from 27 wt % in the flocculated FFT to 91.9 to 97.2 wt % with >98 wt % solids retention. The results for each bag are shown in Table 8. A graph of the weekly sampling data is found in FIG. 7.

TABLE 8
Summary of results for all bag tests in Example 2

| | | | Initial Observations | # Days | Initial Solids | Final Ave |
|---|---|---|---|---|---|---|
| Bag Test | Bag Fill | Bag Name | at Filling | Dewatering | (wt %) | Solids (wt %) |
| 1 | FFT | GT500 | No FFT retention | — | 34.1 | — |
| | | FW700 | Leaked FFT | 28 | 34.1 | 80.7 |
| 2 | FFT | FW500 | Leaked FFT | 28 | 34.1 | 75.4 |
| | | FW700 | Leaked FFT | 28 | 34.1 | 76.7 |
| | | N160 (LP6) | Retained most FFT, | 28 | 34.1 | 82.7 |
| | | | about 5 wt % solids | | | |
| | | | released after 21 days | | | |
| | | N1100 (LP10) | Retained most FFT, | 28 | 34.1 | 83.9 |
| | | | about 5 wt % solids | | | |
| | | | released after 21 days | | | |
| 3 | Floc'd | GT500 | Good solids | 26 | 27.0 | 96.9 |
| | FFT | | retention, <1 wt % | | | |
| | | | solids in released | | | |
| | | | water | | | |
| | | FW500 | Good solids | 26 | 27.0 | 91.9 |
| | | | retention, <1 wt % | | | |
| | | | solids in released | | | |
| | | | water | | | |
| | | FW700 | Very good solids | 26 | 27.0 | 97.2 |
| | | | retention | | | |
| | | N160 (LP6) | Very good solids | 26 | 27.0 | 97.0 |
| | | | retention | | | |

The tests showed that dewatering was enhanced by treating the FFT with a flocculant prior to dewatering in a geotextile bag.

### Example 3

A field trial to dewater untreated FFT, a flocculated FFT and a coagulated mix of FFT-gypsum was undertaken simultaneously to test the efficacy of commercial scale geotextile bag dewatering technology. Nine commercial-sized geotextile enclosed bags (each 240 m³ capacity, 18.3 m circumference×17.4 m long×1.8 m high) were placed in a test area located on a beach above the high water level of the Mildred Lake Settling Basin (MLSB). The test area surface was formed of tailings sand graded to 1% slope draining to the MLSB with a bermed area to the north and sides of the test area to avoid contamination or resaturation of the deposits due to surface water run-off from precipitation or snow melt or tailings lines leaks. The geotextiles and container designs were selected based on the results of the small-scale bag tests of Examples 1 and 2, to maximize container fill height (i.e., ˜2 m) and to provide a balance of permeability (AOS size) and solids retention for optimum dewatering efficiency. Nine commercial scale geotextile bags (240 m³ capacity, 17.4 in long×1.8 m high×18.3 m circumference) were supplied by Layfield Environmental Systems and fabricated by TenCate Geosynthetics Americas. All bags included at least one wall layer constructed of high strength woven polypropylene yarns using commercially available dewatering geotextile known as Mirafi® GT500. Seven of the nine bags were lined with either Mirafi® FW500 or 160N.

The GT500 geotextile container is woven and provides a high tensile strength and high seam strength enabling a higher fill height (e.g., 2 m) with good dewatering performance.

The FW500 woven fabric can also be formed into dewatering containers but its reduced tensile strength relative to GT500 geotextile limits its fill height in this application to significantly less than 2 m. FW500 was selected as an inner liner to the GT500 due to the success of early bench-scale bag tests (Example 1 above).

While the non-woven geotextiles have the benefit of the smaller AOS and provided good bench-scale results, they would normally tend to stretch when loaded with the volumes intended. This stretch increases the AOS and restricts the achievable height to about 0.5 m, reducing their viability for FFT filling and solids retention on a commercial scale.

Thus, the GT500 forms an exoskeleton to retain the lower strength woven FW500 and non-woven 160N geotextiles, enabling a larger tube diameter and higher achievable fill heights (i.e., 1.8 m high when filled).

Each geotextile bag is equipped with two 8″ flanged fill ports and was supplied with a 6″ PVC injection spout “stinger” with camlock fittings to facilitate filling.

The commercial scale geotextile containers (Geotubes®)) were filled with various FFT mixtures. Dewatering performance over time was monitored, including a minimum of 2 freeze-thaw cycles. Based on the results of the small scale bag tests of Example 2, untreated FFT was not introduced to any unlined GT500 containers. In addition, three chemically treated FFT feeds were employed: (i) flocculated FFT using polymer A, (ii) flocculated FFT using polymer V and (iii) coagulated (coag) FFT using gypsum. Polymer V is an anionic polyacrylamide-calcium or magnesium polyacrylate co-polymer with a high molecular weight (about 10,000 kD or higher) and a medium charge density.

Table 9 shows an overview of the nine geotextile containers and their contents.

TABLE 9
Summary of commercial scale tests

| | Geotextile | AOS | | | |
|---|---|---|---|---|---|
| Geotextile | Container | outer/liner | | Initial Solids | |
| Container # | Outer/Liner | (microns) | Fill | (wt %) | Comments |
| 5 | GT500/none | 425/— | Floc FFT | 30.0 | Containers 5 and 6 |
| | | | Polymer V | | compare two different |
| | | | 1340 g/tonne | | polymers; Untreated FFT |
| 6 | GT500/none | 425/— | Floc FFT | 30.3 | did not pass screen test in |
| | | | Polymer A | | GT500 (Example 2) and |
| | | | 1375 g/tonne | | therefore no untreated |
| | | | | | FFT was used in single |
| | | | | | layer GT500; Also, tests 5 |
| | | | | | and 6 compare single |
| | | | | | layer bags against double |
| | | | | | layer bags in the other |
| | | | | | containers. Thus, these |
| | | | | | tests also assessed the use |
| | | | | | of more cost effective, |
| | | | | | single layer walled |
| | | | | | containers to dewater |
| | | | | | flocculated FFT vs. more |
| | | | | | expensive lined |
| | | | | | containers |
| 1 | GT500/FW500 | 425/300 | Untreated FFT | 33.8 | Untreated FFT in lined |
| 8 | GT500/FW500 | 425/300 | Floc FFT | 29.9 | containers was compared |
| | | | Polymer V | | against chemically treated |
| | | | 1510 g/tonne | | FFT in lined and unlined |
| 9 | GT500/FW500 | 425/300 | Floc FFT | 30.8 | containers; Containers 7, |
| | | | Polymer A | | 8 and 9 compare different |
| | | | 1200 g/tonne | | chemically treated FFT |
| 7 | GT500/FW500 | 425/300 | Coag FFT | 33.6 | feeds in one type of |
| | | | Gypsum | | container. |
| | | | 2950 g/tonne | | |
| 2 | GT500/160N | 425/212 | Untreated FFT | 33.8 | Untreated FFT was |
| 3 | GT500/160N | 425/212 | Floc FFT | 31.2 | compared against |
| | | | Polymer A | | chemically treated FFT; |
| | | | 1020 g/tonne | | Containers 3 and 4 |
| 4 | GT500/160N | 425/212 | Coag FFT | 34.3 | compare different |
| | | | Gypsum | | chemically treated FFT |
| | | | 2865 g/tonne | | feeds in one type of |
| | | | | | container. |

A dredge supplied raw FFT from the Mildred Lake Settling Basin which was screened through a ¾ inch screen to remove debris.

The screened raw FFT was fed to containers 1 and 2 via piping and a rubber hose connected to the fill ports.

The geotextile bags 3, 5, 6, 8 and 9 were filled with flocculated FFT in a manner similar to that shown in FIG. 3, wherein the screened FFT was diluted with dyke seepage water to feed a set density to the dynamic mixer. The dyke seepage water was also used to supply a polymer preparation skid which produced the selected polymer (A or V) solution. In order to give the polymer sufficient time to hydrate, the polymer solution was fed to a storage tank equipped with mixers. The diluted FFT feed and hydrated polymer solution was mixed to produce flocculated material. A CSTR (Continuous Stirred Tank Reactor) mixer was used to create the flocculated material. For the polymer A fill, the mixer rpm was at its lowest setting, and for the polymer V fill it was set at the midrange. The CSTR mixer was fed with about 35 wt % solids FFT and generated flocculated material at slightly lower solids density of 33.8 to 34.4 wt %.

Screened FFT treated with gypsum was prepared using the polymer hydration tank as a batch gypsum addition and mixing vessel, and then pumped from the tank to fill the two Geotubes® 4 and 7. Based on the feed FFT solids density 1.25 kg gypsum per m³ volume of FFT provided a gypsum concentration of 2865 to 2950 g/tonne solids FFT.

Flexible hoses (6 inches diameter) were used to connect FFT supply pipelines and the fill ports of the Geotubes®. The flexible hoses were connected to the 8 inch fill ports on each bag and the FFT was injected through the 6″ PVC stinger inserted through the 8″ port.

Pumping was provided by the CSTR mixer for the flocculated materials. The mixer was operated at a flow rate of about 450-500 m³/hr to transport the flocculated material via pipeline to the test area where it was placed in the appropriate geotextile bags. At that rate, the geotextile bags, being 240 m³ in volume, could typically be filled in about 1-2 hours. A small trailer-mounted, diesel booster pump was used to pump FFT-gypsum mix directly from the polymer conditioning tank to the specified bags and was also used directly in-line at slow roll (so as not to shear the floc) to assist with pumping flocculated FFT to the furthest Geotube®.

The Geotubes® were each filled to 1.8 m in height.

Filling occurred in the period September 22 to October 1 which is autumn in northern Alberta, Canada.

After filling, release of water was observed and release water was collected and analyzed. Some FFT fines, bitumen and flocculated FFT fines initially expressed from the Geotubes®. After 24 hours, the release water from all tubes (including Geotubes® 1 and 2) generally cleared up to <1% solids per weight. The Geotubes® containing flocculated FFT initially shed release water much more quickly than the Geotubes® with untreated FFT and gypsum-treated FFT.

The filled Geotubes® were left exposed at ambient conditions through the winter and were sampled and tested for geotechnical properties at the end of the following summer (early September 2014), constituting one freeze thaw cycle. The solids content of the Geotubes® on November 12, May 17, and July 17 were estimated using the TenCate proprietary Geotube® Simulator program, and solids content over time was estimated based on surveyed container elevations (beach and container heights) on the aforementioned dates after initial filling, as shown in Table 10. Actual measured solids content (wt %) on samples taken September 7-9/14 were compared to estimated solids content for the same period and were within 10%.

TABLE 10
Solids Content over Approximately One Year

| | | | | | | | | Measured Solids |
|---|---|---|---|---|---|---|---|---|
| | | | | | | | | 7-Sep. |
| | | | | | Estimated Solids Content | | | 8-Sep. |
| | Geotextile | | Initial Fill | | 12-Nov | 17-May | 17-Jul | 9-Sep. |
| Geotextile | Container | Fill | | Solids | Solids | Solids | Solids | Solids * |
| Container # | Outer/Liner | Material | Date | wt % | wt % | wt % | wt % | Ave wt % |
| 1 | GT500/FW500 | FFT | 29-Sep. | 33.8 | 35.5 | 41.0 | 51.53 | 49.22 |
| | | | # days | 0 | 44 | 230 | 291 | 344 |
| 2 | GT500/160N | FFT | 29-Sep. | 33.8 | 37.0 | 43.1 | 54.29 | 54.10 |
| | | | # days | 0 | 44 | 230 | 291 | 344 |
| 3 | GT500/160N | Polymer A/FFT | 24-Sep. | 31.2 | 39.6 | 45.1 | 56.49 | 59.00 |
| | | | # days | 0 | 49 | 235 | 296 | 349 |
| 4 | GT500/160N | Gypsum/FFT | 30-Sep. | 34.3 | 38.6 | 46.2 | 57.70 | 53.18 |
| | | | # days | 0 | 43 | 229 | 290 | 342 |
| 5 | GT500 | Polymer V/FFT | 27-Sep. | 30.0 | 35.9 | 41.0 | 55.55 | 55.06 |
| | | | # days | 0 | 46 | 232 | 293 | 345 |
| 6 | GT500 | Polymer A/FFT | 23-Sep. | 30.3 | 36.1 | 41.8 | 54.74 | 57.71 |
| | | | # days | 0 | 50 | 236 | 297 | 350 |
| 7 | GT500/FW500 | Gypsum/FFT | 1-Oct. | 33.6 | 38.0 | 45.0 | 57.75 | 58.78 |
| | | | # days | 0 | 42 | 228 | 289 | 343 |
| 8 | GT500/FW500 | Polymer V/FFT | 27-Sep. | 29.9 | 36.8 | 42.8 | 54.94 | 57.28 |
| | | | # days | 0 | 46 | 232 | 293 | 347 |
| 9 | GT500/FW500 | Polymer A/FFT | 23-Sep. | 30.8 | 37.5 | 42.1 | 53.80 | 57.16 |
| | | | # days | 0 | 50 | 236 | 297 | 351 |

With reference to Table 10, it can be seen that the estimated solids content of each Geotube® 1-9 steadily increased between November 12^{th} and July 17^{th}. On September 5-9, a geotechnical site investigation was done to determine the properties of the materials in each Geotube® including the solids content, particle size distribution and undrained shear strength. In particular, core samples were collected from each Geotube® in nominal 0.2 m lengths and analyzed for the aforementioned parameters using techniques known in the art.

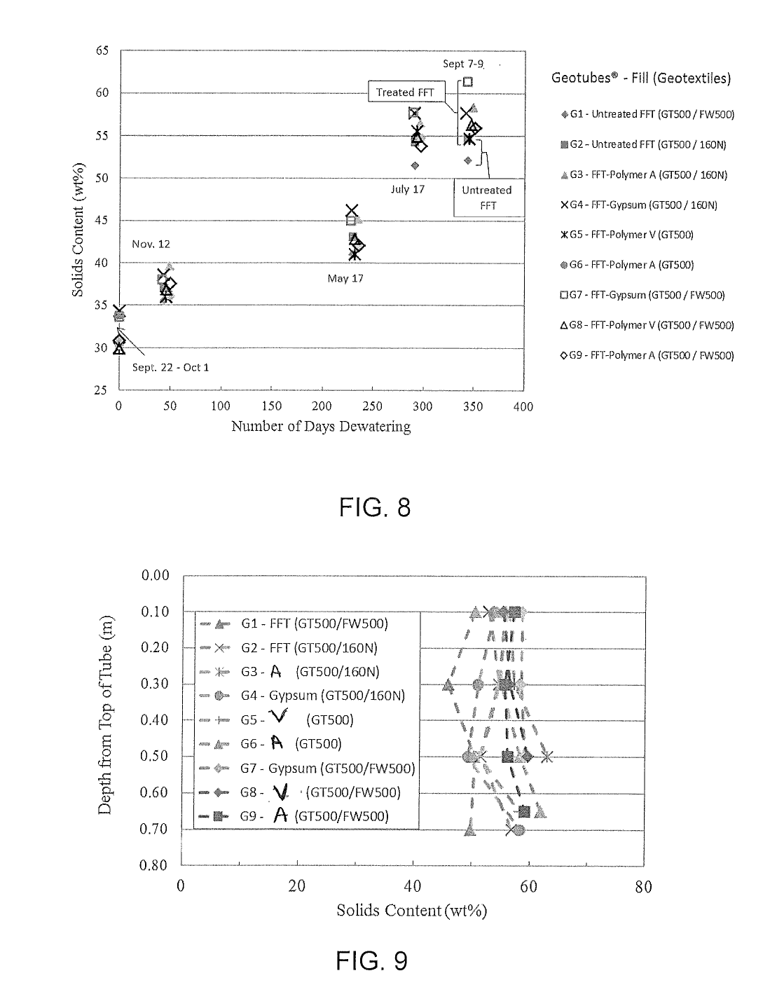

Table 10 further shows that the average measured solids (wt %), which were determined between September 7^{th} and September 9^{th}, also increased for each Geotube® 1-9 from the date of initial filling. However, it can be seen that Geotube® 1 and Geotube® 2, both of which contain FFT without any additive (“Untreated FFT”), had the lowest increase in solids content relative to FFT treated with a coagulant or a flocculant (“Treated FFT”). These results are further shown in FIG. 8.

FIG. 9 shows the solids content of each Geotube® 1-9 at various depths (m) from the top of the Geotube®. While the solids content of most tubes slightly increased the further from the top the samples were taken, it can be seen that generally the solids content was fairly consistent throughout each Geotube®. Thus, dewatering is more uniform from top to bottom of the tubes, indicating more homogeneous deposits with no crust formed within the tube. In the Geotubes® lined with non-woven 160N geotextile, polymer-treated FFT had higher solids content than gypsum or raw FFT deposits. In the Geotubes® lined with FW500 woven geotextile, the polymer and gypsum treated FFT deposits had similar solids content, all of which were higher than the raw FFT deposits. The non-woven 160N lined Geotube® 1 filled with raw FFT had ˜5 wt % higher solids content than Geotube® 2 with the woven FW500 liner.

Thus, there was an increase in solids content when FFT was treated with a flocculant or a coagulant versus untreated (raw) FFT, the average solids content varying from 49.2 wt % for raw FFT to 59.0 wt % for treated FFT.

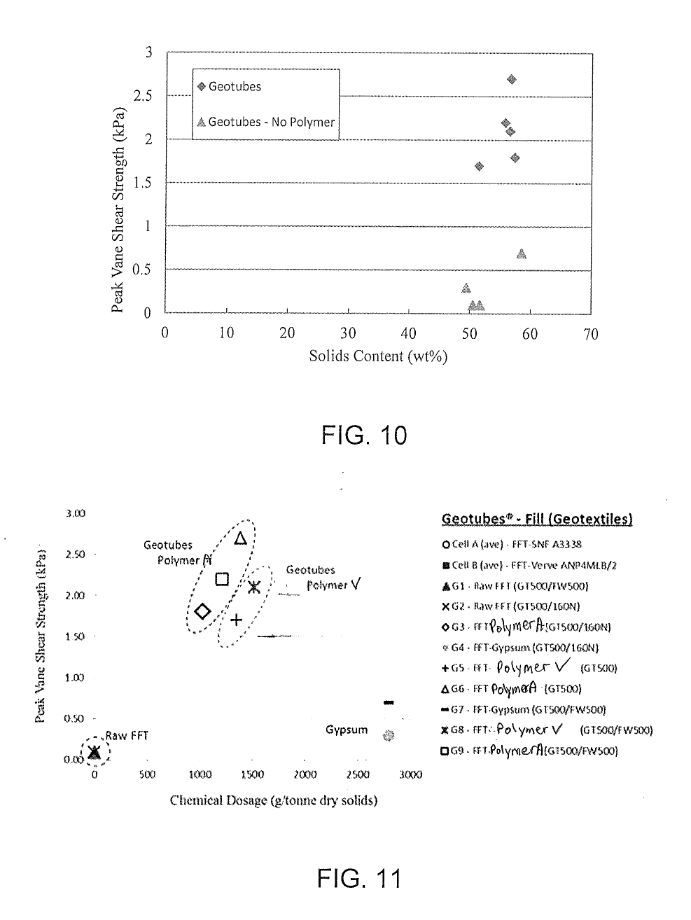

The peak vane shear strengths were also measured for each Geotube® G1-G9 at between 342 days post filling (G4) and 351 days post filling (G9). The results are shown in Table 11. The raw FFT-filled Geotubes® (G1, G2) had essentially no strength and behaved like water, with peak vane shear strengths at or near the minimum resolution (i.e., ˜0.05 kPa). Peak vane shear strengths for the gypsum treated FFT-filled Geotubes® (G4 and G7) were also very low (i.e., <1.0 kPa) and significantly lower than for the polymer treated FFT-filled Geotubes (G3, G5, G6, G8, G9) even though gypsum dose was relatively high. The differences in peak vane shear strengths and solids content (wt %) between polymer-treated FFT-filled Geotubes® and Geotubes® containing FFT not treated with polymer can be seen in FIG. 10. Generally, FFT treated with a polymer had higher solids content and higher peak vane shear strengths. Further, peak vane shear strengths for polymer-treated FFT-filled Geotubes® increased with polymer dosage. This can be seen more clearly in FIG. 11, Thus, GT500 Geotube® filled with polymer A treated FFT at as chemical dose of 1375 g/t dry solids (G6) had the highest measured undrained vane shear strength (2.7 kPa) and solids content (57.7 wt %) combination.

TABLE 11
Peak vane shear strengths (kPa) versus solids content (wt %)

| | Days | Peak Vane | Chemical | | Sept. 5-9 |
|---|---|---|---|---|---|
| | Post | Shear | Dose | Initial | Solids Content |
| Geotextile | Final | Strength | g/t dry | Solids | at Test |
| Container | Fill | Su kPa | solids | (wt %) | Depth (wt %) |
| G1 | 344 | 0.1 | 0 | 33.8 | 49.22 |
| G2 | 344 | 0.1 | 0 | 33.8 | 54.10 |
| G3 | 349 | 1.8 | 1020 | 31.2 | 59.00 |
| G4 | 342 | 0.3 | 2790 | 34.3 | 53.18 |
| G5 | 345 | 1.7 | 1340 | 30.0 | 55.06 |
| G6 | 350 | 2.7 | 1375 | 30.3 | 57.71 |
| G7 | 343 | 0.7 | 2790 | 33.6 | 58.78 |
| G8 | 347 | 2.1 | 1510 | 29.9 | 57.28 |
| G9 | 351 | 2.2 | 1200 | 30.8 | 57.16 |

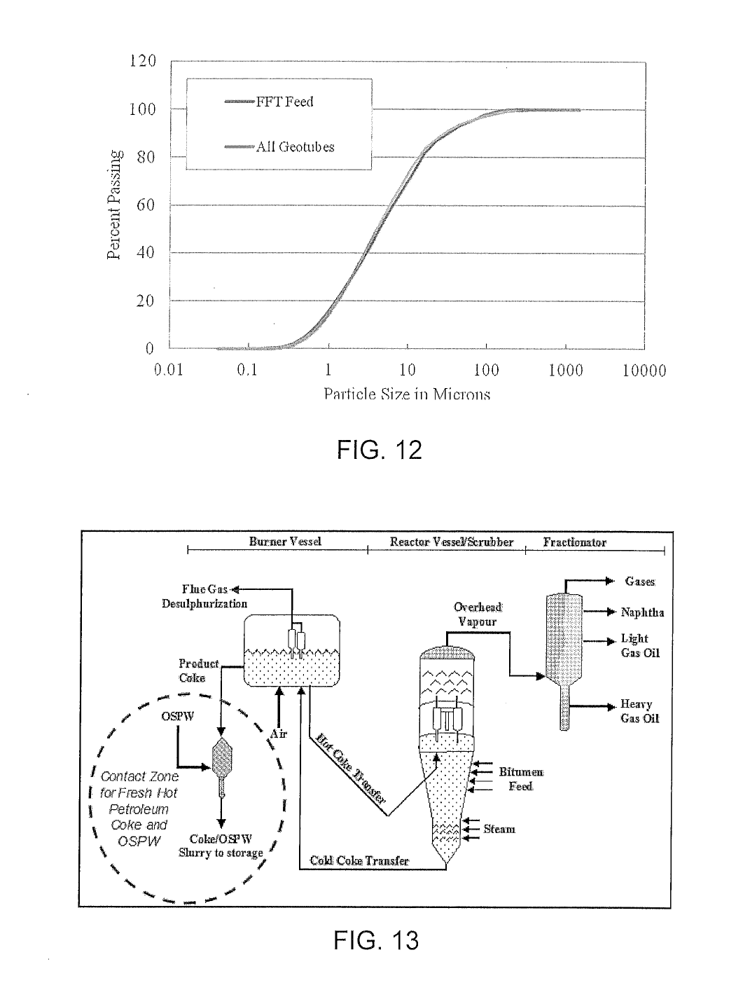

Particle size distribution (PSD) was also determined to see if any segregation of particles had occurred. The results are shown in FIG. 12. FIG. 12 indicates that the PSD of the original FFT feed was consistent with the PSD of the FFT samples obtained from the various Geotubes® after one year.

In summary, this field test provided suitable fill height (˜2 m) to investigate thickness for drainage paths and to avoid changes in the thickness of the container and path length for water to move through the deposit to be released due to the geometry of the bag and distance to travel to the geotextile wall. The field test also allowed comparison of bag types and of chemical treatments versus untreated FFT. Dewatering of untreated tailings was acceptable in suitable bags. However, dewatering of chemically treated tailings is enhanced over untreated tailings, with dewatering of flocculated tailings appearing to be better than dewatering of coagulated tailings.

### Example 4

A simplified process flow diagram of a Fluid Coker useful in upgrading bitumen is shown in FIG. 13. One of the by-products of fluid coking is fluid coke, also referred to as petroleum coke (PC). To prevent the solids inventory from increasing, PC is constantly withdrawn from the burner vessel as product coke. The PC is mixed with OSPW to form a slurry mixture that is transported by pipeline to a designated storage area. Such a fluid coking operation generally produces about 20 kg of product PC per barrel of synthetic crude oil produced.

On average, in one year, as much as about 1.95 million tonnes of product PC (˜220 tonnes/hour) are produced in the Applicant's plant (based on the production of about 97.5 million barrels). The coke sluice lines are designed to transport solid slurries at concentrations of about 20-22 wt %. Geotextile containers can be filled with petroleum coke slurried out to tailings, thus, allowing the petroleum coke to be retained and potentially used for building foundations (e.g., coke spur extensions). Further, the water treated by the fluid coke can be collected using impermeable underliners and used for reclamation purposes (i.e., End Pit Lake capping). Thus, dewatering using geotextile containers has the potential to treat between about 8 and 12 Mm³ of OSPW per year.

From the foregoing description, one skilled in the art can easily ascertain the essential characteristics of this invention, and without departing from the spirit and scope thereof, can make various changes and modifications of the invention to adapt it to various usages and conditions. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

We claim:

1. A process for containing oil sands tailings comprising:
a) introducing an oil sands tailings feed to a geotextile container, the geotextile container fully surrounding the oil sands tailings feed.

2. The process of claim 1, the geotextile container being permeable, further comprising dewatering the oil sand tailings feed by allowing water from the oil sand tailings feed to pass out of the geotextile container.

3. The process of claim 1, further comprising adding a treatment chemical to the oil sands tailings feed to obtain a treated tailings feed, wherein the oil sands tailings feed has an average particle size and adding the treatment chemical increases the average apparent particle size by forming a floc or agglomerate.

4. The process of claim 3, the geotextile container being permeable, further comprising dewatering the treated tailings feed by allowing water from the treated tailings feed to pass out of the geotextile container.

5. The process of claim 3, wherein adding the treatment chemical includes coagulating and/or flocculating particles in the oil sands tailings feed to generate the treated tailings feed.

6. The process of claim 3, wherein adding the treatment chemical includes adding a flocculating polymer at a concentration of about 100 to about 3,000 grams per tonne of solids in the oil sands tailings feed.

7. The process of claim 3, wherein adding the treatment chemical includes adding a coagulant at a concentration of about 100 to about 3,000 grams per tonne of solids in the oil sands tailings feed.

8. The process of claim 1, further comprising obtaining the oil sands tailings feed from a layer of fluid fine tailings in an oil sands tailings storage facility.

9. The process of claim 8, wherein obtaining includes pumping the fluid fine tailings from the oil sands tailings storage facility.

10. The process of claim 1, wherein the geotextile container includes a top wall, a bottom wall and side walls and a fill port and introducing includes sealing the container with a closure on the fill port and exposing it over time to ambient conditions.

11. The process of claim 1, wherein the geotextile container is formed of a geotextile having a minimum average wide width tensile strength of at least 350 lbs/in.

12. The process of claim 1, wherein the geotextile container includes walls of a single layer of geotextile having an apparent opening size of less than 500 microns.

13. The process of claim 1, wherein the geotextile container comprises at least an outer layer of geotextile and a liner of geotextile within the outer layer.

14. The process of claim 13, wherein the outer layer has a greater tensile strength than the liner.

15. The process of claim 13, wherein the outer layer has an apparent opening size larger than the liner.

16. A method for constructing a reclamation landform comprising:
a) placing a geotextile container on a selected ground surface;
b) filling the geotextile container with oil sand tailings;
c) sealing the geotextile container; and
d) adapting the geotextile container to construct a reclamation landform.

17. The method of claim 16, the geotextile container being permeable, further comprising exposing the geotextile container to air to permit water to pass from the oil sand tailings out of the geotextile container.

18. The method of claim 16, the geotextile container being permeable, further comprising exposing the geotextile to sunlight to encourage evaporation of water released from the oil sand tailings.

19. The method of claim 16, wherein the selected ground surface is a flat surface.

20. The method of claim 16, the geotextile container being permeable, wherein the selected ground surface is a surface selected to drain liquids away from below the geotextile container.

21. The method of claim 16, the geotextile container being permeable, wherein the selected ground surface is a sloped surface to encourage the drainage of water away from the geotextile container.

22. The method of claim 16, the geotextile container being permeable, wherein the selected ground surface is lined with a non-permeable membrane to enable released water collection and diversion for plant reuse or release to the environment.

23. The method of claim 16, further comprising obtaining the oil sands tailings from an oil sands tailings pond and chemically treating the oil sands tailings to coagulate and/or flocculate particles in the oil sands tailings.

24. The method of claim 23, wherein chemically treating includes adding a flocculating polymer to the oil sands tailings.

25. The method of claim 16, further comprising obtaining the oil sands tailings from a layer of fluid fine tailings in an oil sands tailings pond.

26. The method of claim 16, wherein the geotextile container is an enclosed geotextile container with a sealable fill port.

27. The method of claim 26, wherein the geotextile container is formed of a geotextile having a minimum average wide width tensile strength of at least 350 lbs/in.

28. The method of claim 26, wherein the geotextile container has an apparent opening size of less than 500 microns.

29. The method of claim 26, wherein the geotextile container comprises an outer layer of geotextile and an inner liner of geotextile.

30. The method of claim 29, wherein the outer layer is stronger than the liner.

31. The method of claim 29, wherein the outer layer has an apparent opening size larger than the liner.

32. The method of claim 16, wherein filling includes filling the geotextile container to a thickness of no more than 2 meters.

33. The method of claim 16, the geotextile container being permeable, further comprising dewatering the oil sands tailings and refilling the geotextile container if a volume of the oil sands tailings is reduced by dewatering.

34. The method of claim 16, further comprising exposing the geotextile container to at least one freeze thaw cycle.

35. The method of claim 16 further comprising placing a second geotextile container on top of the geotextile container; and filling the second geotextile container to form a load on the geotextile container.

36. The method of claim 16, further comprising placing a second layer of geotextile containers on top of the first layer of geotextile containers to create a berm for containment of fluid tailings.

37. The method of claim 10, wherein the side walls are curved and the geotextile container is tubular in shape.

38. The method of claim 1, wherein the geotextile container is impermeable and the tailings feed is essentially permanently retained therein.

39. The method of claim 16, wherein the geotextile container is impermeable and the tailings feed is essentially permanently retained therein.
